(19) United States
(12) Patent Application Publication
(10) Pub. No.: US 2014/0214824 A1
(43) Pub. Date: Jul. 31, 2014

(54) METHOD, DEVICE AND COMPUTER STORAGE MEDIUM FOR ADDING INFORMATION OF FRIENDS

(71) Applicants: Junming Mai, Shenzhen City (CN); Yuhuang Li, Shenzhen City (CN); Yuewen Liu, Shenzhen City (CN); Peng He, Shenzhen City (CN); Chuan Chen, Shenzhen City (CN); Weihua Chen, Shenzhen City (CN)

(72) Inventors: Junming Mai, Shenzhen City (CN); Yuhuang Li, Shenzhen City (CN); Yuewen Liu, Shenzhen City (CN); Peng He, Shenzhen City (CN); Chuan Chen, Shenzhen City (CN); Weihua Chen, Shenzhen City (CN)

(21) Appl. No.: 14/130,127

(22) PCT Filed: Mar. 26, 2013
(86) PCT No.: PCT/CN2013/073188

§ 371 Date: Dec. 30, 2013

(30) Foreign Application Priority Data
May 15, 2012 (CN) 201210150079.7

(51) Int. Cl. G06F 17/30

(52) U.S. Cl. CPC G06F 17/30699; G06F 17/30657
USPC 707/731; 707/736

(57) ABSTRACT

Provided is a method, device and computer storage medium for adding information of friends, and said method includes following steps: acquiring a user ID of a user and a friend ID of a friend of the user from a first network relationship list; according to said user ID and said friend ID, acquiring second correlation information corresponding to said user and said friend from several second network relationship lists; according to said second correlation information, determining first correlation information corresponding to the user and the friend in said first network relationship list, and adding said first correlation information into said first network relationship list. The method and device for adding information of friends provided in the present disclosure can accurately recognize the correlation information corresponding to the user and the friend on the basis of existing network relationship lists, and automatically add remark information for friends of the user.

### TECHNICAL FIELD

The present disclosure relates to the technical field of network information processing, and more particularly to a method for adding information of friends, and a device and a computer storage medium for adding information of friends.

### BACKGROUND OF THE INVENTION

In various kinds of social networking systems, there are a variety of “Groups”, also known as network relationship lists, which reflect relationships in reality. The social networking systems carry huge amounts of network relationship lists; each user has different relationships with others in different network relationship lists; one user also may be listed as a friend in different network relationship lists established by another user.

The correlation information corresponding to a user and a friend of the user in each network relationship list contains information such as remark information for the friend of the user, and so on. The prior art method normally needs users to manually add remark information by users themselves. However, since social networking systems become larger and larger, and there are more and more varieties of social networking systems, the prior art method for adding remark information mentioned above becomes more and more inconvenient, and affects the running efficiency of the system due to multiple operations.

### SUMMARY OF THE INVENTION

In view of the defects existing in the prior art mentioned above, in one aspect, the present disclosure provides a method for adding information of friends which is capable of recognizing the correlation between users automatically and accurately, and automatically adding, for the user, the correlation information relating to friends of the user. In another aspect, the present disclosure provides a device and a computer storage medium to realize the method for adding information of friends mentioned above.

A method for adding information of friends, implemented in electronic equipment, includes following steps:

acquiring a user ID of a user and a friend ID of a friend of the user from a first network relationship list;

according to said user ID and friend ID, acquiring second correlation information corresponding to the user and the friend from several second network relationship lists; and

according to said second correlation information, determining first correlation information corresponding to the user and the friend in said first network relationship list, and adding said first correlation information into said first network relationship list.

A device for adding information of friends, based on electronic equipment containing a processor and a memory, said memory is configured to save program instructions corresponding to said device for adding information of friends, said processor is configured to execute said program instructions corresponding to said device for adding information of friends, wherein, said device for adding information of friends includes:

a tab acquiring module, configured to acquire a user ID of a user and a friend ID of a friend of the user from a first network relationship list;

an information acquiring module, configured to, according to said user ID and friend ID, acquire second correlation information corresponding to the user and the friend from several second network relationship lists;

an information processing module, configured to, according to said second correlation information, determine first correlation information corresponding to the user and the friend in said first network relationship list; and

an information adding module, configured to add said first correlation information into said first network relationship list.

One or more computer media containing computer executable instructions, said computer executable instructions are used for executing the method for adding information of friends.

According to the method and device for adding friends of the present disclosure, the user ID and the friend ID in the first network relationship list are read in the current social networking system; and according to said user ID and friend ID, the second correlation information corresponding to the user and the friend is acquired from the second network relationship lists of other social networking systems. According to said second correlation information, the first correlation information of said first network relationship in the current social networking system is determined. Thereby, the user can add the correlation information from various social networking systems more conveniently; alternatively, the present disclosure can even, based on the existing correlation information, automatically add correlation information from other network relationship lists, such as remark information, without the need of the user's manual marking, which is very convenient and the response efficiency of the system is improved.

### BRIEF DESCRIPTION OF THE DRAWINGS

FIG. 1 is a flow diagram illustrating the method for adding information of friends of the present invention;

FIG. 2 is a partial flow diagram illustrating the method for adding information of friends according to one preferred embodiment of the present invention;

FIG. 3 is a structure diagram illustrating the device for adding information of friends of the present invention;

FIG. 4 is a structure diagram illustrating the information processing module in the device for adding information of friends according to one preferred embodiment of the present invention;

FIG. 5 is a structure diagram illustrating the information adding module in the device for adding information of friends according to one preferred embodiment of the present invention;

FIG. 6 is a schematic diagram illustrating an operating environment of the device for adding information of friends of the present invention.

### DETAILED DESCRIPTION OF THE PREFERRED EMBODIMENTS

As shown in FIG. 1, which is a flow diagram illustrating the method for adding information of friends according to one embodiment of the present invention.

Said method for adding information of friends includes following steps:

S101, acquiring a user ID of a user and a friend ID of a friend of the user from a first network relationship list;

Each social networking system has a respective network relationship list, configured to record relationships among users, such as various kinds of friend lists in social networking systems like instant messaging software, micro-blog, and so on. Said first network relationship list refers to the network relationship list in the current social networking system which needs to add in remark information for friends.

When the user adds information of friends in said social networking system, or adopts other methods to trigger the operation of automatically acquiring information of friends, the user ID (IDentity) and the friend ID in the first network relationship list in the current social networking system will be read.

Said user ID and friend ID may be an identification for identifying the identity of the user and the friend, such as an instant messaging software account, an email account, a telephone number, a social networking service account, and so on; and for example, when the user triggers the operation of automatically acquiring the correlation information corresponding to a certain friend of the user in micro-blog, the micro-blog account of the user and the micro-blog account of the friend will be acquired.

Preferably, said user ID and friend ID are unified identifications corresponding to the user and the friend in network relationship lists of various social networking systems. For example, the user ID and friend ID may be selected from any one of the following options: the unified login account, email account and telephone number adopted in multiple social networking systems by the user and the friend.

When the user has different user IDs in network relationship lists of various social networking systems, the step is specified as follows: acquiring the user ID and friend ID in said first network relationship list from said first network relationship list, and receiving user IDs and friend IDs from several second network relationship lists that are inputted or designated by the user; recording the correspondence between the user ID in the first network relationship list and the user IDs in said several second network relationship lists, and recording the correspondence between the friend ID in the first network relationship list and the friend IDs in said several second network relationship lists.

S102, according to said user ID and friend ID, acquiring second correlation information corresponding to the user and the friend from several second network relationship lists;

Said second network relationship list refers to the network relationship list set by the user in other social networking systems. For example, if said first network relationship list is a friend list of a micro-blog, said second social networking systems may be a friend list of a community forum system, a friend list of a social network, and so on.

In this step of, according to said user ID and friend ID, acquiring second correlation information corresponding to the user and the friend from several second network relationship lists, said second correlation information includes remark information, a name and information set in other social networking systems.

If the user and the friend adopt unified IDs in various social networking systems, then directly search the second correlation information corresponding to the user and the friend in corresponding second network relationship lists according to said user ID and friend ID.

If the user and the friend adopt different IDs in various social networking systems, then acquiring the second correlation information corresponding to the user and the friend from said several second network relationship lists according to the correspondence between the user ID in the first network relationship list and the user IDs in said several second network relationship lists, and the correspondence between the friend ID in the first network relationship list and the friend IDs in said several second network relationship lists.

Said second correlation information contains the information which can remark identity of a friend in various second network relationship lists, such as remark information for friends in a community forum, remark information for friends in an instant messaging software (like user data and a tag), group information (like a group business card), remark information for friends in a social networking service (like a real name, a school name and a company name), remark information for friends in a micro-blog (like personal data and a tag), and so on.

The acquired second correlation information involves a huge amount of business, in different network relationship lists, the relationship between the user and the friend may not be the same, some friends may be colleagues of the user and also be schoolmates. Therefore, preferably, after the second correlation information is acquired, the information should be unified and integrated in a data form of “user-friend-second correlation information”.

For example, if a user A exists in a friend list of micro-blog of a user B, and the remark information is: “xx company, Li xx”, then, the correlation information corresponding to said user A and said user B in the network relationship list of micro-blog is micro-blog friend, xx company and Li xx; while if said user A and said user B have another network relationship in other social networking systems, then the second correlation information corresponding to the second network relationship lists, or the second correlation information corresponding to several of those second network relationship lists are acquired simultaneously.

As a preferred embodiment, after acquiring second correlation information corresponding to the user and the friend from several second network relationship lists, the method further goes to the following step:

according to the user ID, the friend ID, the name of the friend and the second correlation information in said second network relationship lists, generating formatted second correlation information.

The information can be extracted more conveniently through formatted second correlation information.

S103, according to said second correlation information, determining first correlation information corresponding to the user and the friend in said first network relationship list.

According to said second correlation information acquired by the searching above, the first correlation information in said first network relationship list can be obtained.

For example, said second correlation information may be converted to said first correlation information directly, alternatively, some pieces of said second correlation information may be converted to said first correlation information through selecting.

S104, adding said first correlation information into said first network relationship list.

When adding said first correlation information, the first correlation information is added in a preset format of the first network relationship list.

According to the method for adding friends of the present disclosure, the user ID and the friend ID in the first network relationship list are read in the current social networking system; and according to said user ID and friend ID, the second correlation information corresponding to the user and the friend is searched from the second network relationship lists of other social networking systems. According to said second correlation information, the first correlation information of said first network relationship in the current social networking system is determined. Thereby, the user can add the correlation information from various social networking systems more conveniently; alternatively, the present disclosure can even, based on the existing correlation information, automatically add correlation information from other network relationship lists, without the need of the user's manual marking, which is very convenient.

As a preferred embodiment, in order to acquire the first correlation information more accurately, following operations are executed on said second correlation information which is unformatted and may carry noise therein:

segmenting words contained in said second correlation information by word segmentation technology; and

recognizing keywords from segmented words and, according to said keywords, generating said first correlation information.

By means of segmenting words contained in said second correlation information and recognizing keywords, more accurate information can be acquired so as to generate the more accurate first correlation information.

Preferably, said process of recognizing keywords from segmented words further includes the following sub-steps:

tabbing the part of speech of the segmented words and recognizing keywords; and

according to a pre-established noise library, filtering the recognized keywords.

Usually, the second correlation information corresponding to various second network relationship lists is unformatted, which means that the text content of the acquired second correlation information is not organized according to an effective way, for example, a format of a group business card in a schoolmate group is commonly like “department of computer science, ZHANG San”, and said “ZHANG San” is a definite user name, which can be used as remark information for a friend; and said “department of computer science” is an attribute of “ZHANG San”, which can be used as identity information and shall be processed separately. While the noise includes abusive vocabularies, pure symbols, and so on.

Therefore, after the operation of segmenting words contained in said second correlation information by word segmentation technology, the part of speech of each segmented word is recognized through tabbing the part of speech, and the most representative keywords which can represent the friend identity will be recognized. The words which are irrelevant to the friend identity, such as vocabularies which are repeatedly used like “of”, will be filtered. Preferably, said keywords include personal names and organization names which are the most representative keywords to reflect the social relationship; the personal name is the best alternative of remark information for a friend, and the organization name can be used as prompting information of the friend identity.

Then, according to the pre-established noise library, said recognized keywords are filtered so as to filter out abusive vocabularies, pure symbols, and so on. Said noise library may adopt a continuous updating noise library configured to filter the noise from the text. Preferably, new noise vocabularies can be continuously acquired from business data of search engines, input methods, and so on, so as to ensure that the noise can be filtered out effectively. Thereby the more accurate and brief first correlation information can be generated.

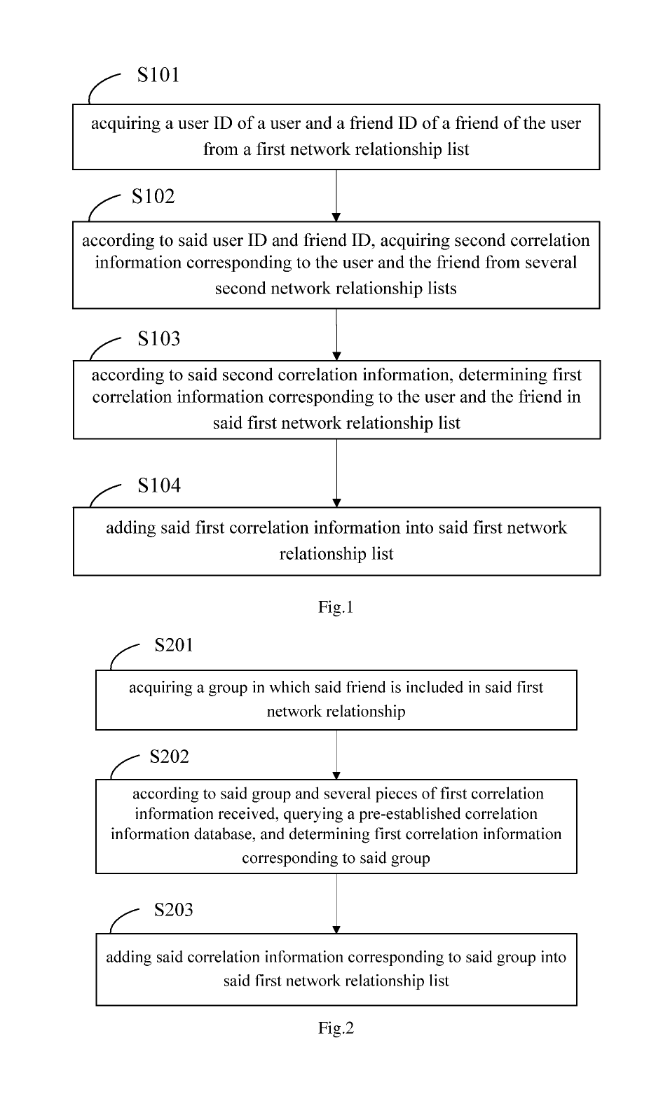

Furthermore, a same friend of the user may have different identities among different groups in the same network relationship list, therefore, preferably when adding said first correlation information into said first network relationship list, following steps, as shown in FIG. 2, are implemented to further acquire the accurate correlation information of the friend in different groups:

S201, acquiring a group in which said friend is included in said first network relationship;

S202, according to said group and several pieces of first correlation information received, querying a pre-established correlation information database, and determining first correlation information corresponding to said group; wherein, several preset groups and preset correlation information corresponding to each of said preset groups are saved in said correlation information database;

S203, adding said correlation information corresponding to said group into said first network relationship list.

The preset groups and preset correlation information in correlation information database can be set manually, alternatively, the relevant groups and corresponding correlation information are extracted from existing network relationship lists.

By means of the process mentioned above, taking advantage of pre-established correlation information database, multiple kinds of first correlation information which may exist corresponding to the user and the friend are classified according to different groups, and the most suitable first correlation information corresponding to each group is acquired and then added. In this way, the process flow of the method of the present disclosure can become more intelligent, convenient and accurate.

Preferably, a method is provided for determining first correlation information corresponding to a group according to a pre-established correlation information database, including the following steps:

extracting in advance group categories corresponding to preset groups in said correlation information database and extracting correlation information features corresponding to said preset correlation information, generating a learning sample, establishing, according to said group categories and correlation information features in the learning sample, correspondence between said group categories and correlation information features, and generating a classifier; and

after acquiring said group in which the friend is included in said first network relationship list and determining acquired several pieces of said first correlation information, determining a group category for said group through said classifier, and selecting among said several pieces of first correlation information according to correlation information features corresponding to said group categories, so as to acquire said first correlation information corresponding to said group.

Wherein, said learning sample may be set manually.

For example, supposing a user whose ID is A, and another user whose ID is B, A and B are friends, A is included in two groups which respectively are “university classmate” and “hometown friend”.

A and B are included in a common group G1, the group business card of B in group G1 is “computer department—ZHANG San”; and A and B are included in another common group G2, the group business card of B in group G2 is “ZHANG San (Shenzhen Guangdong)”.

Said two group business cards mentioned above are acquired as the second correlation information in step 2, which are specified as follows:

The second correlation information 1: computer department—ZHANG San;

The second correlation information 2: ZHANG San (Shenzhen Guangdong).

Then, in S103, first processing the two pieces of second correlation information acquired, to format them and then extract features therefrom so as to generate two pieces of first correlation information. Then, the two pieces of first correlation information are represented as follows:

The first correlation information 1:

Source content: computer department—ZHANG San

Feature of education background: Yes, correlation keywords: computer department

Feature of region: No

Feature of personal name: Yes, correlation keywords: ZHANG San;

The first correlation information 2:

Source content: ZHANG San (Shenzhen Guangdong)

Feature of education background: No

Feature of region: Yes, correlation keywords: Shenzhen Guangdong

Feature of personal name: Yes, correlation keywords: ZHANG San.

Wherein, “feature of education background”, “feature of region” and “feature of personal name” belong to correlation information features. The specific information selected as correlation information features according to different groups can be pre-set, thereby different classifications of groups are distinguished.

Assuming A attempts to add B as a friend in “university classmate” group, then A will execute following operations for adding B as a friend:

acquiring the classification of the group as “schoolmate”; alternatively, the user may modify the group name into a user-defined name, however, the group classification corresponding to each group name is tagged by the present method.

The correlation information features of said first correlation information 1 and said second correlation information 2 are input into the trained classifier, and said classifier selects the first correlation information 2 to be the most suitable correlation information. According to the pre-set learning sample, there is greater correlation between the correlation information feature “feature of education background” and the group classification “schoolmate”, and there is smaller correlation between the correlation information feature “feature of region” and the group classification “schoolmate”.

Therefore, the correlation keywords “ZHANG San” corresponding to the feature of personal name in said first correlation information 2 is added as the friend information, and the correlation keywords “computer department” corresponding to the feature of education background is added as facilitated friend information, because the personal name is the most major feature for recognizing friends.

On the other hand, in view of the embodiment mentioned above, according to the correlation information 1 in the group G1: computer department—ZHANG San, and the correlation information 2 in the group G2: ZHANG San (Shenzhen Guangdong), following learning samples are generated:

Learning sample 1:

Category: Schoolmate

Feature of education background: Yes, (computer department)

Feature of region: No

Feature of personal name: Yes;

Learning sample 2:

Category: Hometown friend

Feature of education background: No

Feature of region: Yes (Shenzhen Guangdong)

Feature of personal name: Yes (ZHANG San).

The two learning samples mentioned above can be used as the basis for generating said classifier.

In this embodiment, the process of selecting the most suitable correlation information among different groups can be processed as a classification issue. The learning sample is generated by means of extracting features from said preset groups and corresponding preset correlation information recorded in said correlation information database; the corresponding classifier is established by machine learning techniques so as to classify, according to corresponding groups, the acquired multiple pieces of possible first correlation information in said first network relationship list. In this way, the matching accuracy of said first correlation information is improved greatly; furthermore, with the updating of said correlation information database, new samples will be continuously generated so as to ensure the matching accuracy of said first correlation information.

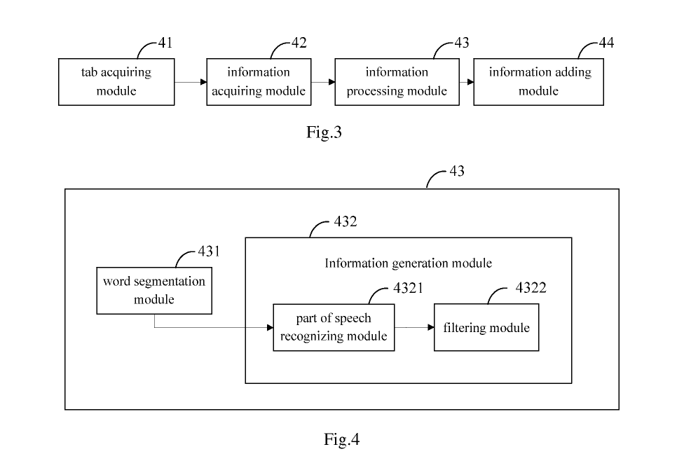

As shown in FIG. 3, which is a structure diagram illustrating the device for adding information of friends, said device for adding information of friends includes: a tab acquiring module 41, an information acquiring module 42, an information processing module 43 and an information adding module 44.

Said tab acquiring module 41 is configured to acquire a user ID of a user and a friend ID of a friend of the user from a first network relationship list; said information acquiring module is configured to, according to said user ID and friend ID, acquire second correlation information corresponding to the user and the friend from several second network relationship lists; said information processing module 43 is configured to, according to said second correlation information, determine first correlation information corresponding to the user and the friend in said first network relationship list; and said information adding module 44 is configured to add said first correlation information into said first network relationship list.

Wherein, said first network relationship list refers to the network relationship list in the current social networking system which needs to add in remark information for friends.

When the user adds information of friends in said social networking system, or adopts other methods to trigger the operation of automatically acquiring information of friends, said tab acquiring module 41 reads the user ID (IDentity) and the friend ID in the first network relationship list in the current social networking system, and the user IDs and friend IDs in several second networking systems.

Said user ID and friend ID may be an identification for identifying the identity of the user and the friend, such as an instant messaging software account, an email account, a telephone number, a social networking service account, and so on; and for example, when the user triggers the operation of automatically acquiring the correlation information corresponding to a certain friend of the user in micro-blog, the micro-blog account of the user and the micro-blog account of the friend will be acquired.

Preferably, said user ID and friend ID read by said tab acquiring module 41 are unified identifications corresponding to the user and the friend in network relationship lists of various social networking systems. For example, said tab acquiring module 41 can select any one of following options as said user ID and friend ID, such as the unified login account, email account and telephone number adopted in multiple social networking systems by the user and the friend.

When the user has different user IDs in network relationship lists of various social networking systems, the step is specified as follows: acquiring the user ID and friend ID in said first network relationship list from said first network relationship list, and receiving user IDs and friend IDs from several second network relationship lists that are input or designated by the user; recording the correspondence between the user ID in the first network relationship list and the user IDs in said several second network relationship lists, and recording the correspondence between the friend ID in the first network relationship list and the friend IDs in said several second network relationship lists.

Said second network relationship list refers to the network relationship list set by the user in other social networking systems. For example, if said first network relationship list is a friend list of a micro-blog, said second social networking systems may be a friend list of a community forum system, a friend list of a social network, and so on.

Said information acquiring module 42 searches the second correlation information corresponding to the user and the friend in corresponding second network relationship lists on the basis of said user ID and friend ID.

If the user and the friend adopt unified IDs in various social networking systems, said information acquiring module 42 searches the second correlation information corresponding to the user and the friend in corresponding second network relationship lists directly according to said user ID and friend ID.

If the user and the friend adopt different IDs in various social networking systems, then said information acquiring module 42 acquires the second correlation information corresponding to the user and the friend from said several second network relationship lists according to the correspondence between the user ID in the first network relationship list and the user IDs in said several second network relationship lists, and the correspondence between the friend ID in the first network relationship list and the friend IDs in said several second network relationship lists.

Said second correlation information contains the information which can remark identity of a friend in various second network relationship lists, such as remark information for friends in a community forum, remark information for friends in an instant messaging software (like user data and a tag), group information (like a group business card), remark information for friends in a social networking service (like a real name, a school name and a company name), remark information for friends in a micro-blog (like personal data and a tag), and so on.

The second correlation information acquired by said information acquiring module 42 involves a huge amount of business, in different network relationship lists, the relationship between the user and the friend may not be the same, some friends may be colleagues of the user and also be schoolmates. Therefore, preferably, after the second correlation information is acquired, the information should be unified and integrated in a data form of “user-friend-second correlation information”.

Said information processing module 43, according to the second correlation information acquired by said information acquiring module 42, can determine the first correlation information corresponding to the user and the friend in said first network relationship list.

For example, said second correlation information can be converted to said first correlation information directly, alternatively, a part of said second correlation information can be converted to said first correlation information through selecting.

When adding said first correlation information, said information adding module 44 adds the first correlation information in a preset format of the first network relationship list.

According to the device for adding friends of the present disclosure, the user ID and the friend ID in the first network relationship list are read in the current social networking system; and according to said user ID and friend ID, the second correlation information corresponding to the user and the friend is acquired from the second network relationship lists of other social networking systems. According to said second correlation information, the first correlation information of said first network relationship in the current social networking system is determined. Thereby, the user can add the correlation information from various social networking systems more conveniently; alternatively, the present disclosure can even, based on the existing correlation information, automatically add correlation information from other network relationship lists, without the need of the user's manual marking, which is very convenient.

As shown in FIG. 4, which is a structure diagram illustrating the information processing module in the device for adding information of friends according to one preferred embodiment of the present invention.

As a preferred embodiment, in order to process said second correlation information, which is unformatted and may contain noise, acquired by said information acquiring module 42, to acquire the first correlation information more accurately, said information processing module 43 includes:

a word segmentation module 431, configured to segment words contained in said second correlation information by word segmentation technology; and

an information generation module 432, configured to recognize keywords from segmented words and, according to said keywords, generate said first correlation information.

By means of segmenting words contained in said second correlation information through said word segmentation module 431 and recognizing the keywords through said information generating module 432, the more accurate information can be acquired, so as to generate the more accurate first correlation information.

Preferably, said information generating module 432 includes following sub-modules:

a part of speech recognizing module 4321, configured to tab the part of speech of said segmented words and recognize keywords; and

a filtering module 4322, configured to, according to a pre-established noise library, filter said recognized keywords.

After said word segmentation module 431 segments words contained in said second correlation information by word segmentation technology, the part of speech of each segmented word is recognized through tabbing the part of speech, and the most representative keywords which can represent the friend identity will be recognized by said part of speech recognizing module 4321. The words which are irrelevant to the friend identity, such as vocabularies which are repeatedly used like “of”, will be filtered. Preferably, said keywords include personal names and organization names which are the most representative keywords to reflect the social relationship; the personal name is the best alternative of remark information for a friend, and the organization name can be used as prompting information of the friend identity.

According to the pre-established noise library, said filtering module 4322 filters said recognized keywords so as to filter out abusive vocabularies, pure symbols, and so on. Said noise library may adopt a continuous updating noise library configured to filter the noise from the text. Preferably, new noise vocabularies can be continuously acquired from business data of search engines, input methods, and so on, so as to ensure that the noise can be filtered out effectively. Thereby the more accurate and brief first correlation information can be generated.

Now turn to FIG. 5, which is a structure diagram illustrating the information adding module in the device for adding information of friends according to one preferred embodiment of the present invention.

As a preferred embodiment, a same friend of the user may have different identities among different groups in the same network relationship list, therefore, when said information adding module 44 adds said first correlation information into said first network relationship list, the accurate correlation information of the friend in different groups can be further acquired. Said information adding module 44 includes the following sub-modules:

a correlation information database 441, configured to save several preset groups and preset correlation information corresponding to said preset groups;

a group information acquiring module 442, configured to acquire groups in which said friend is included in said first network relationship;

a judging sub-module 443, configured to, according to said groups and several pieces of said first correlation information received, query said correlation information database, and determine first correlation information corresponding to said groups; and

an adding module 444, configured to add said correlation information corresponding to said groups into said first network relationship list.

In this embodiment, taking advantage of the pre-established correlation information database 441, multiple kinds of first correlation information which may exist corresponding to the user and the friend are classified according to different groups, and the most suitable first correlation information corresponding to each group is acquired and then added. In this way, the process flow of the method of the present disclosure can become more intelligent, convenient and accurate.

Furthermore, a preferred configuration of said judging sub-module 443 is provided, and said judging sub-module 443 includes the following sub-modules:

a classifier sub-module 4431, configured to extract in advance group category corresponding to said preset groups in said correlation information database and correlation information features corresponding to said preset correlation information, generate a learning sample, establish, according to said group category and correlation information features in the learning sample, correspondence corresponding to said group category and correlation information features, and generate a classifier

a category module 4432, configured to determine a group category for said groups by said classifier, and select among said several pieces of first correlation information according to correlation information features corresponding to said group category, so as to acquire said first correlation information corresponding to said groups.

Wherein, said learning sample may be set manually.

In this way, the process of selecting the most suitable correlation information with different groups can be processed as a classification issue. The learning sample is generated by means of extracting features from said preset groups recorded in said correlation information database and said preset correlation information accordingly; the corresponding classifier is established by machine learning techniques so as to classify, according to corresponding groups, the acquired multiple pieces of possible first correlation information corresponding to said first network relationship list. In this way, the matching accuracy of said first correlation information is improved greatly; furthermore, with the updating of said correlation information database, new samples will be continuously generated so as to ensure the matching accuracy of said first correlation information.

It should be understood by those skilled in the art that all or part of the processes of preferred embodiments disclosed above may be realized through relevant hardware commanded by computer program instructions. Said program may be saved in a computer readable storage medium, and said program may include the processes of the preferred embodiments mentioned above when it is executed. Wherein, said storage medium may be a diskette, optical disk, ROM (Read-Only Memory) or RAM (Random Access Memory), and so on.

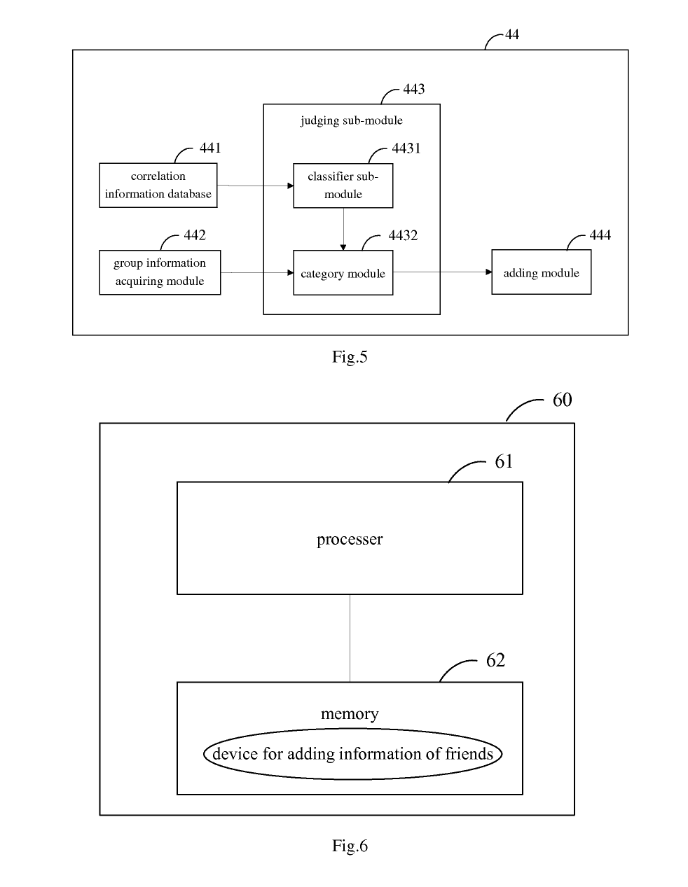

Now turn to FIG. 6, which is a schematic diagram illustrating an operating environment of the device for adding information of friends according to one embodiment of the present invention.

Said device for adding information of friends operates in electronic equipment 60 containing a processer 61 and a memory 62, and said electronic equipment 60 may be a PC, a laptop, a smart phone or other electric devices.

The memory 62, contained in said electric equipment 60, is configured to read and operate program instructions corresponding to said device for adding information of friends, so as to realize the object of automatically adding information of friends illustrated in FIG. 1 to FIG. 5.

It should be understood by those skilled in the art that what described above are preferred embodiments of the present invention. Various modifications and replacements may be made therein without departing from the theory of the present disclosure, which should also be seen in the scope of the present disclosure.

1. A method for adding information of friends, implemented in electronic equipment, comprising:
acquiring a user ID of a user and a friend ID of a friend of the user from a first network relationship list;
according to said user ID and friend ID, acquiring second correlation information corresponding to the user and the friend from several second network relationship lists; and
according to said second correlation information, determining first correlation information corresponding to the user and the friend in said first network relationship list, and adding said first correlation information into said first network relationship list.

2. The method for adding information of friends according to claim 1, wherein, the determining first correlation information corresponding to the user and the friend in said first network relationship list comprises:
segmenting words contained in said second correlation information by word segmentation technology; and
recognizing keywords from segmented words and, according to said keywords, generating said first correlation information.

3. The method for adding information of friends according to claim 2, wherein, the recognizing keywords from segmented words comprises following steps:
tabbing said segmented words and recognizing keywords; and
according to a pre-established noise library, filtering said recognized keywords.

4. The method for adding information of friends according to claim 1, wherein, the adding said first correlation information into said first network relationship list comprises following steps:
acquiring a group in which said friend is included in said first network relationship;
according to said group and received several pieces of said first correlation information, querying a pre-established correlation information database, and determining first correlation information corresponding to said group; wherein, several preset groups and preset correlation information corresponding to each of said preset groups are saved in said correlation information database; and
adding said first correlation information corresponding to said group to said first network relationship list.

5. The method for adding information of friends according to claim 4, wherein, the querying a pre-established correlation information database, and determining first correlation information corresponding to said group comprises following steps:
extracting group categories corresponding to preset groups in said correlation information database and extracting correlation information features corresponding to said preset correlation information, generating a learning sample, establishing, according to said group categories and correlation information features in the learning sample, correspondence between said group categories and correlation information features, and generating a classifier; and
after acquiring said group in which the friend is included in said first network relationship list and determining acquired several pieces of said first correlation information, determining a group category for said group through said classifier, and selecting among said several pieces of first correlation information according to correlation information features corresponding to said group categories, so as to acquire said first correlation information corresponding to said group.

6. A device for adding information of friends, based on electronic equipment containing a processor and a memory, said memory is configured to save program instructions corresponding to said device for adding information of friends, said processor is configured to execute said program instructions corresponding to said device for adding information of friends, wherein, said device for adding information of friends comprises:
a tab acquiring module, configured to acquire a user ID of a user and a friend ID of a friend of the user from a first network relationship list;
an information acquiring module, configured to, according to said user ID and friend ID, acquire second correlation information corresponding to the user and the friend from several second network relationship lists;
an information processing module, configured to, according to said second correlation information, determine first correlation information corresponding to the user and the friend in said first network relationship list; and
an information adding module, configured to add said first correlation information into said first network relationship list.

7. The device for adding information of friends according to claim 6, wherein, said information processing module comprises:
a word segmentation module, configured to segment words contained in said second correlation information by word segmentation technology; and
an information generation module, configured to recognize keywords from segmented words and, according to said keywords, generating said first correlation information.

8. The device for adding information of friends according to claim 7, wherein, said information generating module comprises:
a part of speech recognizing module, configured to tab the part of speech of said segmented words and recognize keywords; and
a filtering module, configured to, according to a pre-established noise library, filter said recognized keywords.

9. The device for adding information of friends according to claim 6, wherein, said information adding module comprises:
a correlation information database, configured to save several preset groups and preset correlation information corresponding to said preset groups;
a group information acquiring module, configured to acquire groups in which said friend is included in said first network relationship;
a judging sub-module, configured to, according to said groups and several pieces of said first correlation information received, query said correlation information database, and determine first correlation information corresponding to said groups; and
an adding module, configured to add said correlation information corresponding to said groups into said first network relationship list.

10. The device for adding information of friends according to claim 9, wherein, said judging sub-module comprises:
a classifier sub-module, configured to extract in advance group category corresponding to said preset groups in said correlation information database and correlation information features corresponding to said preset correlation information, generate a learning sample, establish, according to said group category and correlation information features in the learning sample, correspondence corresponding to said group category and correlation information features, and generate a classifier; and
a category module, configured to determine a group category for said groups by said classifier, and select among said several pieces of first correlation information according to correlation information features corresponding to said group category, so as to acquire said first correlation information corresponding to said groups.

11. One or more non-transitory computer readable storage media, including computer executable instructions, said computer executable instructions are used for executing a method for adding information of friends, wherein, the method comprises:
acquiring a user ID of a user and a friend ID of a friend of the user from a first network relationship list;
according to said user ID and friend ID, acquiring second correlation information corresponding to the user and the friend from several second network relationship lists; and
according to said second correlation information, determining first correlation information corresponding to the user and the friend in said first network relationship list, and adding said first correlation information into said first network relationship list.

12. The one or more non-transitory computer readable storage media according to claim 11, wherein, said determining first correlation information corresponding to the user and the friend in said first network relationship list is specified as following steps:
segmenting words contained in said second correlation information by word segmentation technology; and
recognizing keywords from segmented words and, according to said keywords, generating said first correlation information.

13. The one or more non-transitory computer readable storage media according to claim 12, wherein, said recognizing keywords from segmented words is specified as following steps:
tabbing said segmented words and recognizing keywords; and
according to a pre-established noise library, filtering said recognized keywords.

14. The one or more non-transitory computer readable storage media according to claim 11, wherein, said adding said first correlation information into said first network relationship list is specified as following steps:
acquiring a group in which said friend is included in said first network relationship;
according to said group and received several pieces of said first correlation information, querying a pre-established correlation information database, and determining first correlation information corresponding to said group; wherein, several preset groups and preset correlation information corresponding to each of said preset groups are saved in said correlation information database; and
adding said first correlation information corresponding to said group to said first network relationship list.

15. The one or more non-transitory computer readable storage media according to claim 14, wherein, said querying a pre-established correlation information database, and determining first correlation information corresponding to said group is specified as following steps:
extracting group categories corresponding to preset groups in said correlation information database and extracting correlation information features corresponding to said preset correlation information, generating a learning sample, establishing, according to said group categories and correlation information features in the learning sample, correspondence between said group categories and correlation information features, and generating a classifier; and
after acquiring said group in which the friend is included in said first network relationship list and determining acquired several pieces of said first correlation information, determining a group category for said group through said classifier, and selecting among said several pieces of first correlation information according to correlation information features corresponding to said group categories, so as to acquire said first correlation information corresponding to said group.

16. The method for adding information of friends according to claim 2, wherein, the adding said first correlation information into said first network relationship list comprises following steps:
acquiring a group in which said friend is included in said first network relationship;
according to said group and received several pieces of said first correlation information, querying a pre-established correlation information database, and determining first correlation information corresponding to said group; wherein, several preset groups and preset correlation information corresponding to each of said preset groups are saved in said correlation information database; and
adding said first correlation information corresponding to said group to said first network relationship list.

17. The method for adding information of friends according to claim 3, wherein, the adding said first correlation information into said first network relationship list comprises following steps:
acquiring a group in which said friend is included in said first network relationship;
according to said group and received several pieces of said first correlation information, querying a pre-established correlation information database, and determining first correlation information corresponding to said group; wherein, several preset groups and preset correlation information corresponding to each of said preset groups are saved in said correlation information database; and
adding said first correlation information corresponding to said group to said first network relationship list.

18. The device for adding information of friends according to claim 7, wherein, said information adding module comprises:
a correlation information database, configured to save several preset groups and preset correlation information corresponding to said preset groups;
a group information acquiring module, configured to acquire groups in which said friend is included in said first network relationship;
a judging sub-module, configured to, according to said groups and several pieces of said first correlation information received, query said correlation information database, and determine first correlation information corresponding to said groups; and
an adding module, configured to add said correlation information corresponding to said groups into said first network relationship list.

19. The device for adding information of friends according to claim 8, wherein, said information adding module comprises:
a correlation information database, configured to save several preset groups and preset correlation information corresponding to said preset groups;
a group information acquiring module, configured to acquire groups in which said friend is included in said first network relationship;
a judging sub-module, configured to, according to said groups and several pieces of said first correlation information received, query said correlation information database, and determine first correlation information corresponding to said groups; and
an adding module, configured to add said correlation information corresponding to said groups into said first network relationship list.

20. The one or more non-transitory computer readable storage media according to claim 13, wherein, said adding said first correlation information into said first network relationship list is specified as following steps:
acquiring a group in which said friend is included in said first network relationship;
according to said group and received several pieces of said first correlation information, querying a pre-established correlation information database, and determining first correlation information corresponding to said group; wherein, several preset groups and preset correlation information corresponding to each of said preset groups are saved in said correlation information database; and
adding said first correlation information corresponding to said group to said first network relationship list.
